(19) United States
(12) Patent Application Publication
(10) Pub. No.: US 2023/0292326 A1
(43) Pub. Date: Sep. 14, 2023

(54) DCI FORMAT THAT INDICATES TO MONITOR FOR PAGING DCI

(71) Applicant: Lenovo (Singapore) Pte. Ltd., New Tech Park (SG)

(72) Inventors: Hyejung Jung, Northbrook, IL (US); Joachim Loehr, Wiesbaden (DE); Ravi Kuchibhotla, Chicago, IL (US); Vijay Nangia, Woodridge, IL (US)

(21) Appl. No.: 18/019,601

(22) PCT Filed: Aug. 3, 2021
(86) PCT No.: PCT/IB2021/057119

§ 371 Date: Feb. 3, 2023

Related U.S. Application Data
(60) Provisional application No. 63/060,556, filed on Aug. 3, 2020.

(51) Int. Cl. H04W 72/23; H04W 68/02; H04W 76/28

(52) U.S. Cl. CPC H04W 72/23; H04W 68/02; H04W 76/28

(57) ABSTRACT

Apparatuses, methods, and systems are disclosed for power-efficient paging reception. One apparatus includes a processor and a transceiver that receives a PDCCH configuration of a first DCI format, where the PDCCH configuration includes a search space configuration of the first DCI format. Via the transceiver, the processor detects the first DCI format by monitoring the first DCI format according to the search space configuration, where the first DCI format indicates whether the apparatus is to monitor for paging DCI of a second DCI format. The processor monitors for paging DCI of the second DCI format in a paging period based on the detected first DCI format.

### CROSS-REFERENCE TO RELATED APPLICATIONS

This application claims priority to U.S. Provisional Patent Application No. 63/060,656 entitled “METHOD FOR POWER EFFICIENT PAGING RECEPTION” and filed on Aug. 3, 2020 for Hyejung Jung, Joachim Loehr, Ravi Kuchibhotla, and Vijay Nangia, which application is incorporated herein by reference.

### FIELD

The subject matter disclosed herein relates generally to wireless communications and more particularly relates to power-efficient paging in a radio access network (“RAN”).

### BACKGROUND

Reduced capability User Equipment (“UE”) devices—such as industrial wireless sensors, video surveillance, and wearables—may need to be operated with the battery that should last from multiple days (e.g., wearables) to at least few years (e.g., industrial sensors). Even for enhanced mobile broadband (“eMBB”) and/or ultra-reliable low-latency communication (“URLLC”) UEs, reducing UE power consumption is critical to provide better experiences to end users and to enable new use cases.

### BRIEF SUMMARY

Disclosed are procedures for power-efficient paging reception. Said procedures may be implemented by apparatus, systems, methods, or computer program products.

One method of a User Equipment (“UE”) for power-efficient paging reception includes receiving, from a Radio Access Network (“RAN”) node, a Physical Downlink Control Channel (“PDCCH”) configuration of a first Downlink Control Information (“DCI”) format, where the PDCCH configuration includes a search space configuration of the first DCI format. The method includes detecting the first DCI format by monitoring the first DCI format according to the search space configuration, where the first DCI format indicates whether the UE is to monitor for paging DCI of a second DCI format. The method includes monitoring for paging DCI of the second DCI format in a paging period based on the detected first DCI format.

One method of a RAN node for power-efficient paging reception includes transmitting to a UE device a PDCCH configuration of a first DCI format, where the PDCCH configuration includes a search space configuration of the first DCI format. The method includes transmitting the first DCI format according to the search space configuration, where the first DCI format indicates that the UE device is to monitor for paging DCI of a second DCI format. The method includes transmitting paging DCI of the second DCI format in a paging period indicated by the transmitted first DCI format.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for power-efficient paging reception;

FIG. 2 is a block diagram illustrating one embodiment of a Fifth-Generation (“5G”) New Radio (“NR”) protocol stack;

FIG. 3 is a signaling flow diagram illustrating one embodiment of a procedure for power-efficient paging;

FIG. 4A is a diagram illustrating one embodiment of a DownlinkConfigCommonSIB information element used for power-efficient paging reception;

FIG. 4B is a continuation of the DownlinkConfigCommonSIB information element illustrated in FIG. 4A;

FIG. 5A depicts a diagram illustrating one embodiment of a RRCRelease message used for power-efficient paging reception;

FIG. 5B is a continuation of the RRCRelease message illustrated in FIG. 5A;

FIG. 6 is a block diagram illustrating one embodiment of a user equipment apparatus that may be used for power-efficient paging reception;

FIG. 7 is a block diagram illustrating one embodiment of a network equipment apparatus that may be used for power-efficient paging reception;

FIG. 8 is a block diagram illustrating one embodiment of a first method for power-efficient paging reception; and

FIG. 9 is a block diagram illustrating one embodiment of a second method for power-efficient paging reception.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for reducing unnecessary UE reception of paging DCI and/or paging messages for UE power saving.

Reduced capability UEs such as industrial wireless sensors, video surveillance, and wearables may need to be operated with the battery that should last from multiple days (e.g., wearables) to at least few years (e.g., industrial sensors). Even for eMBB and/or URLLC UEs, reducing UE power consumption is critical to provide better experiences to end users and to enable new use cases.

The present disclosure addresses how to improve power efficiency of paging monitoring and reception. Before a UE monitors paging DCI on a paging occasion, the UE may have to perform measurements on at least one Synchronization Signal and Physical Broadcast Channel (“SS/PBCH”) block of a camped cell in order to select a suitable SS/PBCH block (“SSB”) and determine a paging DCI monitoring occasion corresponding to the selected SSB, which may cause additional UE power consumption for paging reception. Thus, it may be beneficial for UE power saving that a network entity can indicate a UE to skip monitoring of paging DCI and/or reception of a paging message not intended to the UE.

In various embodiments, a UE monitors Paging Power Saving Physical Downlink Control Channel (“PPS-PDCCH”) that indicates whether to monitor paging DCI in a paging occasion of a given Discontinuous Reception (“DRX”) cycle. A Radio Network Temporary Identifier (“RNTI”) used for scrambling Cyclic Redundancy Check (“CRC”) in PPS-PDCCH is determined based on at least one selected from a Paging Frame index, a Paging Occasion index, and a UE ID.

In various embodiments, a UE in an RRC_INACTIVE mode receives an indication to go to an RRC_IDLE mode implicitly and/or explicitly via PPS-PDCCH.

3GPP Release 16 (“Rel-16”) NR power saving PDCCH (i.e., DCI format 2_6) was designed for a connected mode UE (i.e., in CM-connected mode and RRC_CONNECTED state). Thus, a power savings RNTI (“PS-RNTI”) and a bit field starting position in DCI format 2_6 is UE-specifically configured. However, the proposed paging power saving (PPS)-PDCCH is also intended to idle or inactive UEs. Since an RNTI of PPS-PDCCH is determined based on at least one selected from a Paging Frame (“PF”) index, a Paging Occasion (“PO”) index, and a UE ID, a UE can autonomously determine an associated RNTI to receive a PPS-PDCCH intended to the UE.

In Rel-16 NR, an inactive UE can go to an idle mode by decoding a paging message. In the proposed method, the inactive UE can go to the idle mode by receiving PPS-PDCCH without monitoring paging DCI and decoding the paging message, which can reduce UE power consumption.

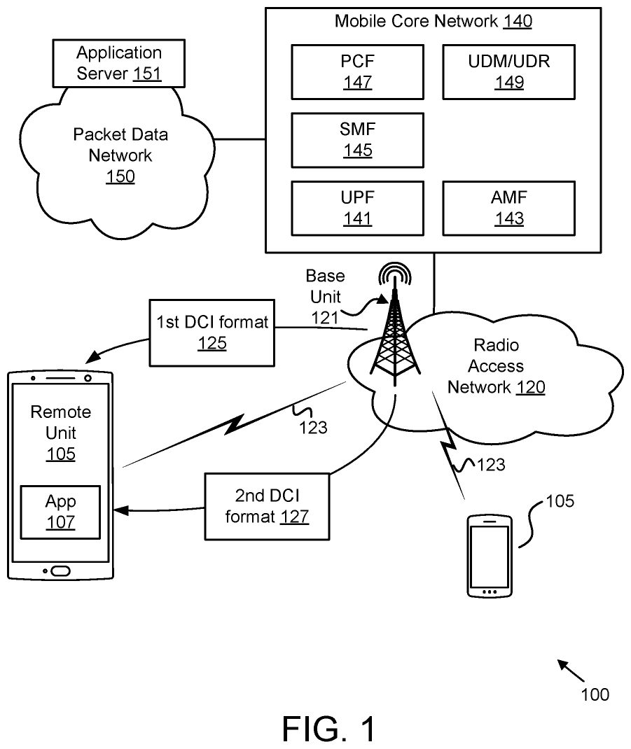

FIG. 1 depicts a wireless communication system 100 for power-efficient paging reception, according to embodiments of the disclosure. In one embodiment, the wireless communication system 100 includes at least one remote unit 105, a radio access network (“RAN”) 120, and a mobile core network 140. The RAN 120 and the mobile core network 140 form a mobile communication network. The RAN 120 may be composed of a base unit 121 with which the remote unit 105 communicates using wireless communication links 123. Even though a specific number of remote units 105, base units 121, wireless communication links 123, RANs 120, and mobile core networks 140 are depicted in FIG. 1, one of skill in the art will recognize that any number of remote units 105, base units 121, wireless communication links 123, RANs 120, and mobile core networks 140 may be included in the wireless communication system 100.

In one implementation, the RAN 120 is compliant with the 5G system specified in the Third Generation Partnership Project (“3GPP”) specifications. For example, the RAN 120 may be a Next Generation Radio Access Network (“NG-RAN”), implementing New Radio (“NR”) Radio Access Technology (“RAT”) and/or Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Here, the RAN 120 is an intermediate network that provides the remote units 105 with access to the mobile core network 140. As described in greater detail below, the base unit 121 may send a first DCI format to the remote unit 105 that indicates whether the remote unit 105 is to monitor for a second DCI format 127. Here, the second DCI format may be a paging DCI, wherein the remote unit 105 then receives a paging message from the base unit using resources indicated in the second DCI format 127.

In some embodiments, the remote units 105 communicate with an application server 151 via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 140 via the RAN 120. The mobile core network 140 then relays traffic between the remote unit 105 and the application server 151 in the packet data network 150 using the PDU session. The PDU session represents a logical connection between the remote unit 105 and the User Plane Function (“UPF”) 141.

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR operation on unlicensed spectrum (referred to as “NR-U”), the base unit 121 and the remote unit 105 communicate over unlicensed (i.e., shared) radio spectrum.

In one embodiment, the mobile core network 140 is a 5GC or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the RAN 120, a Session Management Function (“SMF”) 145, a Policy Control Function (“PCF”) 147, a Unified Data Management function (“UDM””) and a User Data Repository (“UDR”). Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (“DN”), in the 5G architecture. The AMF 143 is responsible for termination of NAS signaling, NAS ciphering & integrity protection, registration management, connection management, mobility management, access authentication and authorization, security context management. The SMF 145 is responsible for session management (i.e., session establishment, modification, release), remote unit (i.e., UE) Internet Protocol (“IP”) address allocation & management, DL data notification, and traffic steering configuration of the UPF 141 for proper traffic routing.

The PCF 147 is responsible for unified policy framework, providing policy rules to CP functions, access subscription information for policy decisions in UDR. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 149.

In various embodiments, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the SGC. When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

While FIG. 1 depicts components of a 5G RAN and a 5G core network, the described embodiments for power-efficient paging reception apply to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA 2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PDN Gateway (“PGW”), a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “RAN node” is used for the base station but it is replaceable by any other radio access node, e.g., gNB, ng-eNB, eNB, Base Station (“BS”), Access Point (“AP”), etc. Further, the operations are described mainly in the context of 5G NR. However, the below described solutions/methods are also equally applicable to other mobile communication systems supporting power-efficient paging reception.

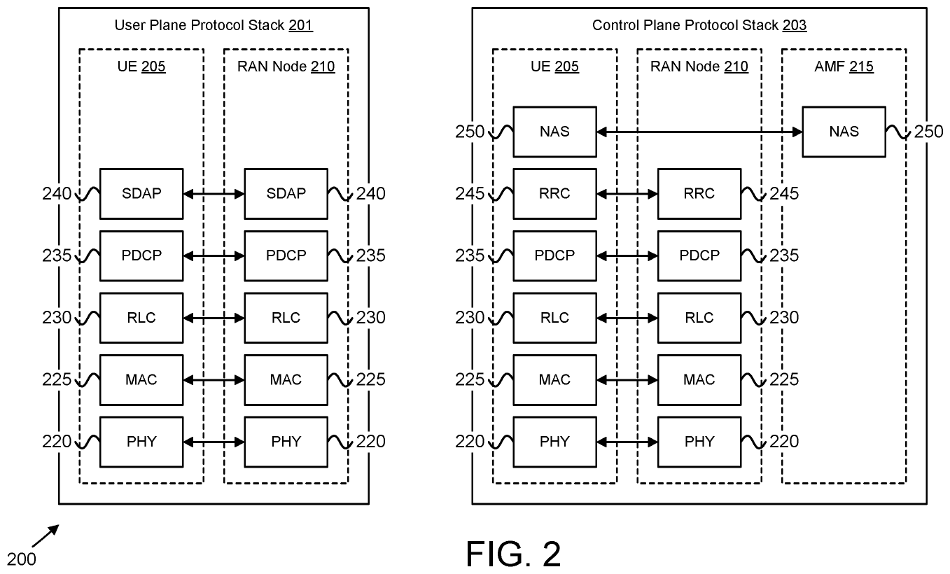

FIG. 2 depicts a NR protocol stack 200, according to embodiments of the disclosure. While FIG. 2 shows the UE 205, the RAN node 210 and an AMF 215 in a 5G core network (“5GC”), these are representative of a set of remote units 105 interacting with a base unit 121 and a mobile core network 140. As depicted, the protocol stack 200 comprises a User Plane protocol stack 201 and a Control Plane protocol stack 203. The User Plane protocol stack 201 includes a physical (“PHY”) layer 220, a Medium Access Control (“MAC”) sublayer 225, the Radio Link Control (“RLC”) sublayer 230, a Packet Data Convergence Protocol (“PDCP”) sublayer 235, and Service Data Adaptation Protocol (“SDAP”) layer 240. The Control Plane protocol stack 203 includes a physical layer 220, a MAC sublayer 225, a RLC sublayer 230, and a PDCP sublayer 235. The Control Plane protocol stack 203 also includes a Radio Resource Control (“RRC”) layer 245 and a Non-Access Stratum (“NAS”) layer 250.

The AS layer (also referred to as “AS protocol stack”) for the User Plane protocol stack 201 consists of at least SDAP, PDCP, RLC and MAC sublayers, and the physical layer. The AS layer for the Control Plane protocol stack 203 consists of at least RRC, PDCP, RLC and MAC sublayers, and the physical layer. The Layer-2 (“L2”) is split into the SDAP, PDCP, RLC and MAC sublayers. The Layer-3 (“L3”) includes the RRC sublayer 245 and the NAS layer 250 for the control plane and includes, e.g., an Internet Protocol (“IP”) layer and/or PDU Layer (not depicted) for the user plane. L1 and L2 are referred to as “lower layers,” while L3 and above (e.g., transport layer, application layer) are referred to as “higher layers” or “upper layers.”

The physical layer 220 offers transport channels to the MAC sublayer 225. The physical layer 220 may perform a Clear Channel Assessment and/or Listen-Before-Talk (“CCA/LBT”) procedure using energy detection thresholds, as described herein. In certain embodiments, the physical layer 220 may send a notification of UL Listen-Before-Talk (“LBT”) failure to a MAC entity at the MAC sublayer 225. The MAC sublayer 225 offers logical channels to the RLC sublayer 230. The RLC sublayer 230 offers RLC channels to the PDCP sublayer 235. The PDCP sublayer 235 offers radio bearers to the SDAP sublayer 240 and/or RRC layer 245. The SDAP sublayer 240 offers QoS flows to the core network (e.g., 5GC). The RRC layer 245 provides for the addition, modification, and release of Carrier Aggregation and/or Dual Connectivity. The RRC layer 245 also manages the establishment, configuration, maintenance, and release of Signaling Radio Bearers (“SRBs”) and Data Radio Bearers (“DRBs”).

The NAS layer 250 is between the UE 205 and the 5GC (i.e., AMF 215). NAS messages are passed transparently through the RAN. The NAS layer 250 is used to manage the establishment of communication sessions and for maintaining continuous communications with the UE 205 as it moves between different cells of the RAN. In contrast, the AS layer is between the UE 205 and the RAN (i.e., RAN node 210) and carries information over the wireless portion of the network.

Regarding System SI change indication and Public Warning System (“PWS”) notification, a modification period is used, i.e., updated System Information (“SI”) message (other than SI message for Earthquake and Tsunami Warning System (“ETWS”), Commercial Mobile Alert System (“CMAS”) and positioning assistance data) is broadcasted in the modification period following the one where SI change indication is transmitted. The modification period boundaries are defined by System Frame Number (“SFN”) values for which SFN mod m=0, where m is the number of radio frames comprising the modification period. The modification period is configured by system information. The UE receives indications about SI modifications and/or PWS notifications using Short Message transmitted with Paging Radio Network Temporary Identifier (“P-RNTI”) over DCI. Repetitions of SI change indication may occur within preceding modification period. SI change indication is not applicable for SI messages containing positioning System Information Blocks (“posSIBs”).

In various embodiments, UEs 205 in RRC_IDLE or in RRC_INACTIVE are to monitor for SI change indication in its own paging occasion every DRX cycle. In contrast, UEs 205 in RRC_CONNECTED are to monitor for SI change indication in any paging occasion at least once per modification period if the UE is provided with common search space on the active BWP to monitor paging.

For PWS, ETWS- or CMAS-capable UEs in RRC_IDLE or in RRC_INACTIVE are to monitor for indications about PWS notification in its own paging occasion every DRX cycle. ETWS- or CMAS-capable UEs in RRC_CONNECTED shall monitor for indication about PWS notification in any paging occasion at least once every defaultPagingCycle if the UE 205 is provided with common search space on the active BWP to monitor paging.

For Short Message reception in a paging occasion, the UE 205 monitors the PDCCH monitoring occasion(s) for paging. If the UE 205 receives a Short Message, then if the UE 205 is ETWS capable or CMAS capable, the etwsAndCmasIndication bit of Short Message is set, and the UE 205 is provided with searchSpaceOtherSystemInformation on the active BWP or the initial BWP, the UE 205 is to immediately re-acquire the SIB1.

If the UE 205 is ETWS capable and si-SchedulingInfo includes scheduling information for SIB6, then the UE 205 is to acquire SIB6, immediately. If the UE 205 is ETWS-capable and si-SchedulingInfo includes scheduling information for SIB7, then the UE 205 is to acquire SIB7, immediately. If the UE 205 is CMAS-capable and si-SchedulingInfo includes scheduling information for SIB8, then the UE 205 acquires SIB8, immediately. Note that in case SIB6, SIB7, or SIB8 overlap with a measurement gap it is left to UE implementation how to immediately acquire SIB6, SIB7, or SIB8. If the systemInfoModification bit of Short Message is set, then the UE 205 is to apply the SI acquisition procedure from the start of the next modification period.

Regarding paging, in general the purpose of this procedure is to transmit paging information to a UE 205 in RRC_IDLE or RRC_INACTIVE. In various embodiments, the network initiates the paging procedure by transmitting the Paging message at the UE's paging occasion. The network may address multiple UEs within a Paging message by including one PagingRecord for each UE 205. Paging messages are indicated by a specific P-RNTI carried within the DCI. Once detecting such a DCI, the UE demodulates and decodes the corresponding PDSCH to extract the paging message(s). There may be multiple paging messages, corresponding to different UEs, within the same paging transmission.

Regarding reception of the Paging message by the UE 205, upon receiving the Paging message, then if the UE 205 is in RRC_IDLE, then for each of the PagingRecord included in the Paging message, if any, then if the ue-Identity included in the PagingRecord matches the UE identity allocated by upper layers, the UE 205 forwards the ue-Identity and accessType (if present) to the upper layers. However, upon receiving the Paging message in RRC_INACTIVE, then for each of the PagingRecord, if any, included in the Paging message, if the ue-Identity included in the PagingRecord matches the UE's stored fullI-RNTI, then if the UE 205 is configured by upper layers with Access Identity 1, the UE 205 initiates the RRC connection resumption procedure with resumeCause set to mps-PriorityAccess.

Else if the UE is configured by upper layers with Access Identity 2, then the UE 205 initiates the RRC connection resumption procedure with resumeCause set to mcs-PriorityAccess. Else, if the UE is configured by upper layers with one or more Access Identities equal to 11-15, then the UE 205 initiates the RRC connection resumption procedure with resumeCause set to highPriorityAccess. Else, the UE 205 initiates the RRC connection resumption procedure with resumeCause set to mt-Access.

If the ue-Identity included in the PagingRecord matches the UE identity allocated by upper layers, then the UE 205 forwards the ue-Identity to upper layers and accessType (if present) to the upper layers. The UE 205 may perform the actions upon going to RRC_IDLE with release cause ‘other’.

Regarding Sort Messages, Short Messages can be transmitted on PDCCH using P-RNTI with or without associated Paging message using Short Message field in DCI format 1_0. Table 1 defines Short Messages. Bit 1 is the most significant bit.

TABLE 1
Short Messages

| Bit | Short Message |
|---|---|
| 1 | systemInfoModification |
| | If set to 1: indication of a BCCH modification |
| | other than SIB6, SIB7 and SIB8. |
| 2 | etwsAndCmasIndication |
| | If set to 1: indication of an ETWS primary |
| | notification and/or an ETWS secondary |
| | notification and/or a CMAS notification. |
| 3 | stopPagingMonitoring |
| | If set to 1: stop monitoring PDCCH occasions(s) |
| | for paging in this PO. |
| 4-8 | Not used in this release of the specification, |
| | and shall be ignored by UE if received. |

If stopPagingMonitoring bit is set to 1, the UE 205 may stop monitoring PDCCH monitoring occasion(s) for paging in that Paging Occasion (“PO”), e.g., as specified in TS 38.304.

A DCI transports downlink control information for one or more cells with one RNTI. The DCI formats defined in Table 2 are supported in NR.

TABLE 2
DCI formats

| DCI format | Usage |
|---|---|
| 0_0 | Scheduling of PUSCH in one cell |
| 0_1 | Scheduling of one or multiple PUSCH in one cell, |
| | or indicating downlink feedback |
| | information for configured grant PUSCH (CG-DFI) |
| 0_2 | Scheduling of PUSCH in one cell |
| 1_0 | Scheduling of PDSCH in one cell |
| 1_1 | Scheduling of PDSCH in one cell, and/or |
| | triggering one shot HARQ-ACK codebook |
| | feedback |
| 1_2 | Scheduling of PDSCH in one cell |
| 2_0 | Notifying a group of UEs of the slot format, |
| | available RB sets, COT duration and |
| | search space set group switching |
| 2_1 | Notifying a group of UEs of the PRB(s) |
| | and OFDM symbol(s) where UE may assume |
| | no transmission is intended for the UE |
| 2_2 | Transmission of TPC commands for PUCCH and PUSCH |
| 2_3 | Transmission of a group of TPC commands for |
| | SRS transmissions by one or more UEs |
| 2_4 | Notifying a group of UEs of the PRB(s) and |
| | OFDM symbol(s) where UE cancels the |
| | corresponding UL transmission from the UE |
| 2_5 | Notifying the availability of soft resources |
| 2_6 | Notifying the power saving information outside |
| | DRX Active Time for one or more |
| | UEs |
| 3_0 | Scheduling of NR sidelink in one cell |
| 3_1 | Scheduling of LTE sidelink in one cell |

The fields defined in the DCI formats below are mapped to the information bits α₀ to α_{A-1} as follows.

Each field is mapped in the order in which it appears in the description, including the zero-padding bit(s), if any, with the first field mapped to the lowest order information bit α₀ and each successive field mapped to higher order information bits. The most significant bit of each field is mapped to the lowest order information bit for that field, e.g., the most significant bit of the first field is mapped to α₀.

If the number of information bits in a DCI format is less than 12 bits, zeros shall be appended to the DCI format until the payload size equals 12.

The size of each DCI format is determined by the configuration of the corresponding active bandwidth part of the scheduled cell and may be adjusted, if necessary.

The following information is transmitted by means of the DCI format 1_0 with CRC scrambled by P-RNTI:
Short Messages Indicator—2 bits according to Table 3, below.
Short Messages—8 bits, e.g., according to Clause 6.5 of 3GPP TS 38.331. If only the scheduling information for Paging is carried, this bit field is reserved.
Frequency domain resource assignment—┌log₂(N_{RB}^{DL,BWP}(N_{RB}^{DL,BWP}+1)/2┐ bits. If only the short message is carried, this bit field is reserved.
N_{RB}^{DL,BWP} is the size of CORESET 0
Time domain resource assignment −4 bits, e.g., as defined in Clause 5.1.2.1 of 3GPP TS 38.214. If only the short message is carried, this bit field is reserved.
VRB-to-PRB mapping −1 bit. If only the short message is carried, this bit field is reserved.
Modulation and coding scheme −5 bits, e.g., as defined in Clause 5.1.3 of 3GPP TS 38.214. If only the short message is carried, this bit field is reserved.
TB scaling−2 bits, e.g., as defined in Clause 5.1.3.2 of 3GPP TS 38.214. If only the short message is carried, this bit field is reserved.
Reserved bits—8 bits for operation in a cell with shared spectrum channel access; otherwise, 6 bits

TABLE 3
Short Message indicator

| Bit field | Short Message indicator |
|---|---|
| 00 | Reserved |
| 01 | Only scheduling information for Paging |
| | is present in the DCI |
| 10 | Only short message is present in the DCI |
| 11 | Both scheduling information for Paging and |
| | short message are present in the |
| | DCI |

Regarding Discontinuous Reception for paging, the UE 205 may use Discontinuous Reception (“DRX”) in RRC_IDLE and RRC_INACTIVE state in order to reduce power consumption. The UE 205 monitors one paging occasion (“PO”) per DRX cycle. A PO is a set of PDCCH monitoring occasions and can consist of multiple time slots (e.g., subframe or OFDM symbol) where paging DCI can be sent (see, e.g., TS 38.213). One Paging Frame (PF) is one Radio Frame and may contain one or multiple PO(s) or starting point of a PO.

In multi-beam operations, the UE 205 assumes that the same paging message and the same Short Message are repeated in all transmitted beams and thus the selection of the beam(s) for the reception of the paging message and Short Message is up to UE implementation. The paging message is same for both RAN-initiated paging and CN-initiated paging.

In various embodiments, the UE 205 initiates RRC Connection Resume procedure upon receiving RAN-initiated paging. If the UE receives a CN-initiated paging in RRC_INACTIVE state, the UE moves to RRC_IDLE and informs NAS.

The PF and PO for paging are determined by the following formulae:
SFN for the PF is determined by:
   (SFN+PF_offset) mod T=(T div N)*(UE_ID mod N)
Index (i_s), indicating the index of the PO is determined by:
   i_s=floor (UE_ID/N) mod Ns

The PDCCH monitoring occasions for paging are determined according to pagingSearchSpace, e.g., as specified in 3GPP TS 38.213, and firstPDCCH-MonitoringOccasionOfPO and nrofPDCCH-MonitoringOccasionPerSSB-InPO if configured, e.g., as specified in 3GPP TS 38.331. When SearchSpaceId=0 is configured for pagingSearchSpace, the PDCCH monitoring occasions for paging are same as for RMSI, e.g., as defined in clause 13 in 3GPP TS 38.213.

When SearchSpaceId=0 is configured for pagingSearchSpace, Ns is either 1 or 2. For Ns=1, there is only one PO which starts from the first PDCCH monitoring occasion for paging in the PF. For Ns=2, PO is either in the first half frame (i_s=0) or the second half frame (i_s=1) of the PF.

When SearchSpaceId other than 0 is configured for pagingSearchSpace, the UE 205 monitors the (i_s+1)th PO. A PO is a set of ‘S*X’ consecutive PDCCH monitoring occasions where ‘S’ is the number of actual transmitted SSBs determined according to ssb-PositionsInBurst in SIB1 and X is the nrofPDCCH-MonitoringOccasionPerSSB-InPO if configured or is equal to 1 otherwise. The [x*S+K]th PDCCH monitoring occasion for paging in the PO corresponds to the K^{th} transmitted SSB, where x=0,1, . . . ,X−1, K=1, 2, . . . ,S. The PDCCH monitoring occasions for paging which do not overlap with UL symbols (determined according to tdd-UL-DL-ConfigurationCommon) are sequentially numbered from zero starting from the first PDCCH monitoring occasion for paging in the PF.

When firstPDCCH-MonitoringOccasionOfPO is present, the starting PDCCH monitoring occasion number of (i_s+1)th PO is the (i_s+1)th value of the firstPDCCH-MonitoringOccasionOfPO parameter; otherwise, it is equal to i_s*S*X. IfX>1, when the UE detects a PDCCH transmission addressed to P-RNTI within its PO, the UE is not required to monitor the subsequent PDCCH monitoring occasions for this PO.

Note that a PO associated with a PF may start in the PF or after the PF. Also note that the PDCCH monitoring occasions for a PO can span multiple radio frames. When SearchSpaceId other than 0 is configured for paging-SearchSpace the PDCCH monitoring occasions for a PO can span multiple periods of the paging search space.

The following parameters are used for the calculation of PF and i_s above: T: DRX cycle of the UE (T is determined by the shortest of the UE specific DRX value(s),
if configured by RRC and/or upper layers, and a default DRX value broadcast in system information. In RRC_IDLE state, if UE specific DRX is not configured by upper layers, the default value is applied).
N: number of total paging frames in T
Ns: number of paging occasions for a PF
PF offset: offset used for PF determination
UE_ID: SG-S-TMSI mod 1024

Parameters Ns, nAndPagingFrameOffset, nrofPDCCH-MonitoringOccasionPerSSB-InPO, and the length of default DRX Cycle are signaled in SIB1. The values of N and PF_offset are derived from the parameter nAndPagingFrameOffset as defined in TS 38.331. The parameter first-PDCCH-MonitoringOccasionOfPO is signaled in SIB1 for paging in initial DL BWP. For paging in a DL BWP other than the initial DL BWP, the parameter first-PDCCH-MonitoringOccasionOfPO is signaled in the corresponding BWP configuration.

If the UE 205 has no SG-S-TMSI, for instance when the UE 205 has not yet registered onto the network, then the UE 205 is to use as default identity UE_ID=0 in the PF and i_s formulas above. SG-S-TMSI is a 48 bit long bit string as defined in TS 23.501. SG-S-TMSI shall in the formulae above be interpreted as a binary number where the left most bit represents the most significant bit.

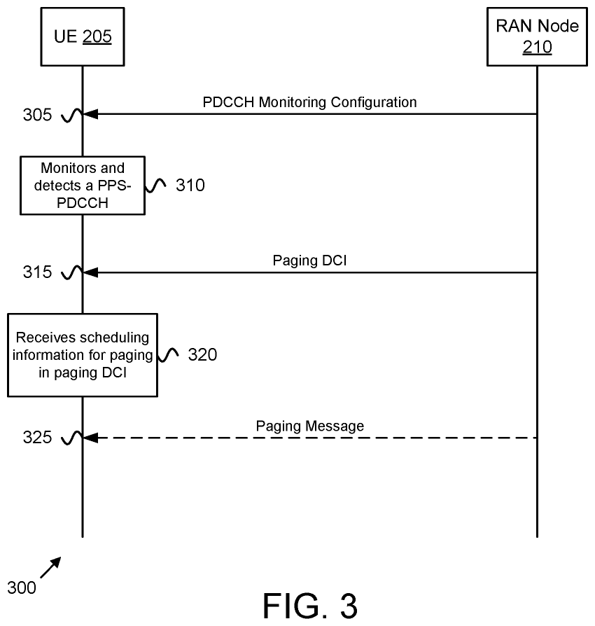

FIG. 3 depicts a signaling flow for a procedure 300 for paging reception, according to embodiments of the disclosure. The UE 205 receives a PDCCH monitoring configuration 305 from the RAN node 210, as described in further detail below. Here, the PDCCH configuration includes a search space configuration of the first DCI format (e.g., used to indicate whether the UE 205 is to monitor for paging DCI of a second format). In the depicted embodiment, it is assumed that the first DCI format in the detected PPS-PDCCH indicates that the UE 205 is to monitor for paging DCI (see block 310).

Accordingly, the UE 205 monitors paging PDCCH in order to receive a paging DCI 315 from the RAN node 210. Here, the paging DCI indicates that the UE 205 is to decode for a paging message (see block 320). Thereafter, the UE 205 receives and decodes a PDSCH in order to receive the paging message 325 from the RAN node 210.

According to embodiments of a first solution, the UE 205 is configured to monitor a first DCI format which is used to indicate whether monitoring of paging DCI is required for a given paging period. In one embodiment, a UE 205 receives a PDCCH monitoring configuration of a first DCI format (e.g., DCI format 2_x) indicating whether the UE 205 should monitor paging DCI in a given paging cycle (i.e., a DRX cycle used for determining a Paging Frame (“PF”) and a Paging Occasion (“PO”)) or in a given system information modification period, where the paging DCI includes scheduling information for a paging message and/or a short message. The UE 205 monitors the first DCI format according to the received PDCCH monitoring configuration. In response to detecting the first DCI format, the UE 205 determines whether to additionally monitor the paging DCI in the given paging cycle or DRX cycle (denoted “paging/DRX cycle”) or the given system information modification period based on the detected DCI format. As such, the first DCI may be an early paging indication, e.g., using Paging Power Saving (“PPS”)-PDCCH.

In certain embodiments, before a UE 205 monitors paging DCI on a paging occasion, the UE may have to perform measurements on at least one synchronization signal and PBCH (“SS/PBCH”) block of a camped cell, in order to select a suitable SS/PBCH block (“SSB”) and accordingly determine a paging DCI monitoring occasion corresponding to the selected SSB from the paging occasion. Note that the paging occasion comprises a set of paging DCI monitoring occasions. Using the first DCI to indicate to the UE 205 whether to monitor the paging DCI on an upcoming paging occasion(s) of a paging/DRX cycle(s) or during an upcoming system information modification period(s) may be used to reduce power consumption of the UE 205, thereby allowing the UE 205 to avoid an unnecessary wake-up for the measurements on a suitable SSB and for blind decoding of the paging DCI.

In one implementation, the DCI format may indicate that the UE 205 is to skip monitoring the paging DCI over a number of DRX cycles or over a number of system information (“SI”) modification periods for power saving. For example, if potential applications for the UE 205 is delay-tolerant—or if the UE 205 is of a particular type or access class (e.g., based on a (signaled) capability of the UE 205 or a UE 205 with reduced capability), then a network (e.g., RAN) may delay paging the UE 205. In another example, if the network intends not to change, for a certain time period, particular system information that a particular group of UEs (or a particular class of UEs) have to maintain and if the UE is one or the particular group of UEs, the network can indicate the UE 205 to skip monitoring the paging DCI over multiple SI modification periods.

In another implementation, the DCI format may indicate (implicitly and/or explicitly) that a UE 205 in an RRC_INACTIVE mode to go to an RRC_IDLE mode. In one example, the UE 205 transitions to the RRC_IDLE mode upon receiving an indication to skip monitoring the paging DCI over a number of DRX cycles in the DCI format. Such a UE 205 may also be configured (e.g., via a RRCRelease message including a parameter ‘SuspendConfig-r17’) to not wake up for the next paging/DRX cycle(s) if the DCI format is not detected. In another example, the UE 205 transitions to the RRC IDLE mode upon receiving a configured or predefined number of consecutive indications to skip monitoring the paging DCI over a number of DRX cycles in the DCI format. In this way, a UE 205 in RRC_INACTIVE mode can transition to RRC_IDLE mode without having to decode a paging message, which reduces decoding of PDCCH (i.e., paging DCI) and PDSCH (i.e., paging message).

For an RRC_INACTIVE state, a core network (e.g., 5GC) still considers a UE 205 in an RRC_INACTIVE mode to be in the CN_CONNECTED state (i.e., signifying that the UE has established connection with the core network). Therefore, if RAN paging is directing a UE 205 in an RRC_INACTIVE mode to transition to the RRC_IDLE mode, a network function (entity) in the CN (e.g., the AMF 215) is to be informed of the RRC state transition and accordingly, the RAN node 210 which sent the paging DCI is to inform the CN (e.g., the AMF 215). Alternatively, the UE 205 may inform the CN (e.g., AMF 215) of the RRC state transition via NAS signaling.

In one implementation, a Paging Power Saving Physical Downlink Control Channel (“PPS-PDCCH”) monitoring configuration may be included in a system information message (e.g., in System Information Block #1 (“SIB1”) with information element ServingCellConfigCommonSIB′) or a dedicated cell group configuration message (e.g., with IE ‘ServingCellConfigCommon’). A UE 205 in idle mode and/or inactive mode may monitor PPS-PDCCH according to the PPS-PDCCH monitoring configuration signaled in the system information message, in order to determine whether to monitor paging DCI on a corresponding paging occasion of a given DRX cycle. A UE 205 in connected mode may monitor PPS-PDCCH according to the PPS-PDCCH monitoring configuration signaled in the dedicated cell group to configuration message, in order to determine whether to monitor paging DCI on any monitoring occasion within a system information modification period.

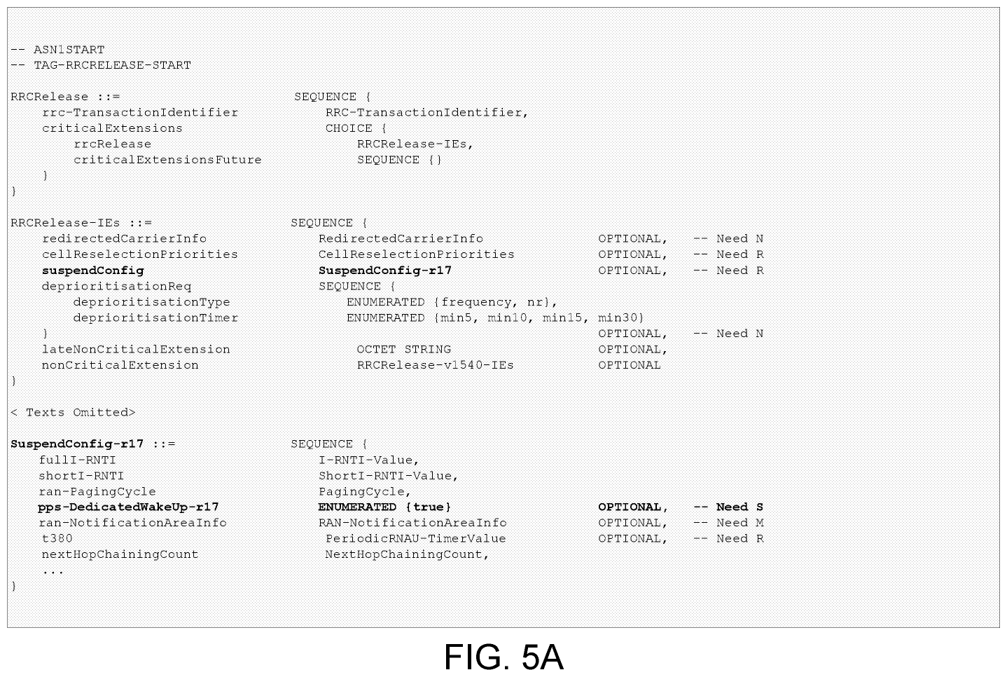

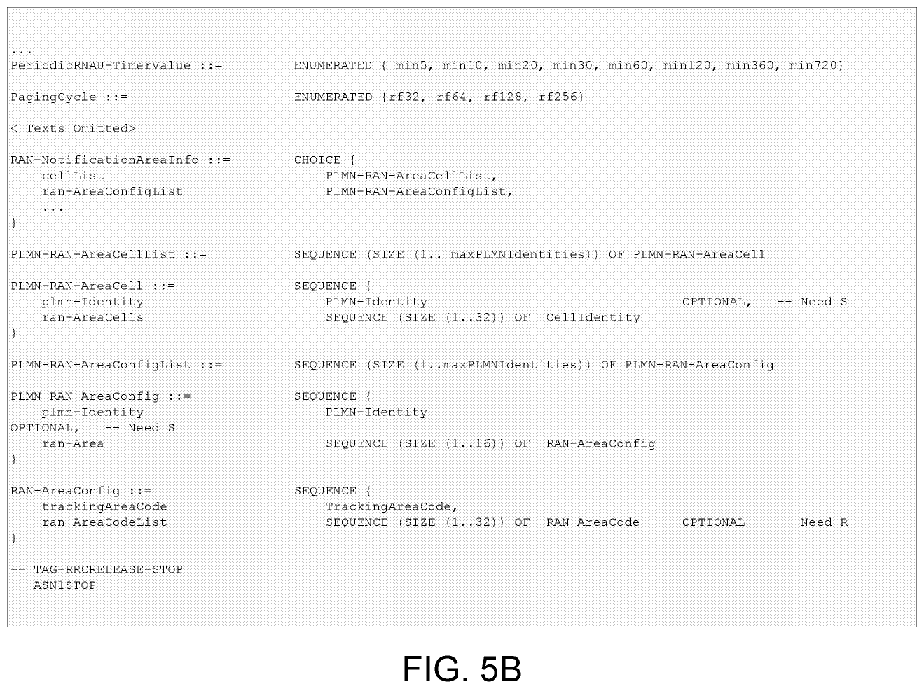

In another implementation, a PPS-PDCCH monitoring configuration may be included in an RRC release message including the parameter ‘suspendConfig’ (i.e., information required for an RRC inactive mode), as described below with reference to FIGS. 5A-5B. An is inactive mode UE may monitor PPS-PDCCH according to the PPS-PDCCH monitoring configuration signaled in the RRC release message, in order to determine whether to monitor paging DCI on a corresponding paging occasion of a given DRX cycle.

A UE 205 may receive at least one search space configuration associated with a DCI format of PPS-PDCCH, where each of the at least one search space configuration may include the parameters ‘duration’ (i.e., the number of consecutive slots that a SearchSpace lasts in every occasion) and ‘monitoringSymbolsWithinSlot’ (i.e., the first symbol(s) for PDCCH monitoring in the slots configured for PDCCH monitoring). The DCI format of PPS-PDCCH may be monitored in a common search space, if the PPS-PDCCH is a group-common PDCCH (intended to a group of UEs) or a common PDCCH (intended to all UEs camping on or being served by a cell, i.e., a “paging all indicator”). In case that the UE 205 is in RRC_INACTIVE or RRC_CONNECTED mode, the UE 205 is configured to monitor PPS-PDCCH, PPS-PDCCH may be a UE-specific PDCCH (i.e., intended to one UE) and may be monitored in a UE-specific search space (i.e., intended to one UE). Thus, while more than one UE may receive and/or decode a UE-specific PDCHH or UE-specific search space, the information contained in the UE-specific PDCCH, or UE-specific search space is only for the specific UE.

In one implementation, at least one PDCCH monitoring occasion of a DCI format of PPS-PDCCH is configured based on a paging cycle, e.g., before a start of a corresponding paging cycle. A UE 205 may receive a time offset value with respect to the start of the corresponding paging cycle in terms of a number of subframes, a number of slots, and/or a number of predefined time units (e.g., 1 ms). The UE 205 identifies the at least one PDCCH monitoring occasion of the DCI format intended for the UE 205 based on cell-specifically configured or UE-specifically configured paging cycle (equivalently, DRX cycle) and additionally the cell-specifically configured or UE-specifically configured timing offset value. In one example, a PPS-PDCCH transmitted on the at least one PDCCH monitoring occasion by a network entity (e.g., RAN node 210) may be intended to all UEs that camp on or are served by a cell.

In another implementation, at least one PDCCH monitoring occasion of a DCI format of PPS-PDCCH intended for a UE 205 is configured based on a Paging Frame, e.g., before a start of a corresponding Paging Frame of the UE 205 in a given paging cycle. The UE 205 may receive a time offset value with respect to the start of the Paging Frame of the UE 205 in terms of a number of subframes, a number of slots, and/or a number of predefined time units (e.g., 0.5 ms). The UE 205 identifies the at least one PDCCH monitoring occasion of the DCI format intended for the UE 205 based on the Paging Frame of the UE 205 and additionally based on a cell-specifically configured timing offset value or on a UE-specifically configured timing offset value. In one example, a PPS-PDCCH on the at least one PDCCH monitoring occasion may be intended to a group of UEs in a cell, where the group of UEs are associated with the Paging Frame.

In yet another implementation, at least one PDCCH monitoring occasion of a DCI format of PPS-PDCCH intended for a UE 205 is configured based on a Paging Occasion, e.g., before a start of a corresponding Paging Occasion of a corresponding Paging Frame of the UE 205 in a given paging cycle. The UE 205 may receive a time offset value with respect to the start of the Paging Occasion of the Paging Frame of the UE 205 in terms of a number of subframes, a number of slots, and/or a number of predefined time units (e.g., 0.125 ms). The UE 205 identifies the at least one PDCCH monitoring occasion of the DCI format intended for the UE 205 based on the Paging Occasion of the Paging Frame of the UE 205 and additionally cell-specifically configured or UE-specifically configured timing offset value. In one example, a PPS-PDCCH on the at least one PDCCH monitoring occasion may be intended to a group of UEs in a cell, where the group of UEs are associated with the Paging Occasion of the Paging Frame.

In the above mentioned implementations, a PPS-PDCCH monitoring periodicity may be same as or a multiple of a paging/DRX cycle. Furthermore, a PPS-PDCCH can indicate not to monitor paging DCI or to monitor paging DCI over multiple paging/DRX cycles. In one example, if the UE 205 does not receive a PPS-PDCCH, the UE 205 monitors the paging DCI in a paging/DRX cycle. A UE 205 may skip monitoring PPS-PDCCH on a configured PPS-PDCCH monitoring occasion(s) associated with UE's paging occasion in a given paging/DRX cycle if the UE 205 has already determined whether to monitor paging DCI in the paging occasion of the given paging/DRX cycle by having received an indication to skip or not to skip monitoring the paging DCI in the given paging/DRX cycle.

If more than one SS/PBCH block is transmitted in a cell, in one implementation, each PPS-PDCCH monitoring occasion of a set of PPS-PDCCH monitoring occasions is associated with a particular SS/PBCH block or a particular TRS/CSI-RS resource (i.e., a particular downlink beam), and a UE 205 needs to monitor PPS-PDDCH only on a PPS-PDCCH monitoring occasion(s) associated with a selected SS/PBCH block or TRS/CSI-RS resource. Further, the UE 205 may be configured to have a PPS-PDCCH monitoring occasion(s) close to a paging DCI monitoring occasion(s) so that beam measurements performed by the UE 205 are applicable to both PPS-PDCCH monitoring and paging DCI monitoring. In one example, a non-zero gap occurs between a PPS-PDCCH monitoring and paging DCI monitoring (e.g., PPS-PDCCH monitoring may be restricted e.g., in terms of bandwidth, to allow for low power mode operation for monitoring PPS-PDCCH compared to paging DCI and associated PDSCH). If the UE 205 is configured or dynamically indicated (i.e., via previous PPS-PDCCH) to monitor PPS-PDCCH not in every paging/DRX cycle but once over multiple paging/DRX cycles, reduced power consumption regarding paging DCI reception is expected.

In another implementation, a UE 205 receives a Control Resource Set (“CORESET”) and search space configuration for PPS-PDCCH, where the CORESET is configured with a particular Transmission Configuration Indicator (“TCI”) state associated with a particular SSB or Channel State Information Reference Signal (“CSI-RS”) resource.

In one implementation, a Radio Network Temporary Identifier (“RNTI”) value used for scrambling a Cyclic Redundancy Check (“CRC”) in a PPS-PDCCH that indicates whether to monitor paging DCI in the next paging cycle is predefined and fixed. The PPS-PDCCH may be intended to all UEs 205 that camps on, or are served by, a cell. In one example, each bit field in DCI of the PPS-PDCCH may comprise one bit and correspond to a group of UEs associated with a particular Paging Occasion of a particular Paging Frame. In another example, each bit field in DCI may comprise N bits, where each of N bits correspond to a sub-group of UEs from the group of UEs associated with the particular Paging Occasion of the particular Paging Frame.

A UE 205 may receive information of bit field configuration such as a number of bits per Paging Frame and/or a number of bits per Paging Occasion. Further, the UE 205 may determine locations of a bit field and a bit(s) within the bit field intended to the UE 205 based on the bit field configuration information and/or a UE identity (e.g., SG-S-TMSI mod 1024, a UE group identity). In one example, the bit field for the UE starts at the k-th bit, where k=N_{PO}·(F·Nₛ+iₛ), where F is a PF index for UE's PF, iₛ is a PO index for UE's PO, Nₛ is the number of POs within a PF, N_{PO} is the number of bits in a bit field corresponding to a PO, and the indices k, F, and is starts from the value zero.

In another implementation, an RNTI value used for scrambling a CRC in a PPS-PDCCH is determined based on at least one selected from a Paging Frame index and a Paging Occasion index. The PPS-PDCCH (e.g., DCI with CRC scrambled by at least a portion of the RNTI) is determined based on at least one selected from a Paging Frame index and a Paging Occasion index. The PPS-PDCCH may be intended to a group of UEs associated with the Paging Frame index or a group of UEs associated with the Paging Frame index and the Paging Occasion index. For example, the RNTI (e.g., referred to as PPS-RNTI) is determined as follows:

PPS-RNTI=C+F·Nₛ+iₛ,

where C is a predefined, configured, or a hash value dependent on SFN (and/or Hyper-SFN) of a particular PF, F is a PF index for the particular PF, iₛ is a PO index, Nₛ is the number of POs within a PF. A UE may receive information of DCI configuration such as a total number of bits in DCI and/or a number of bits per Paging Occasion, and may determine locations of a bit field and a bit(s) within the bit field intended to the UE based on the DCI configuration information and/or a UE identity. To determine the RNTI value, the UE may further use a UE identity (e.g., if UE is in RRC_INACTIVE or RRC_CONNECTED state).

According to embodiments of a second solution, a reduced capability UE(s) receives a separate paging-related parameter set from a paging-related parameter set for a normal UE(s). In one implementation, the separate paging-related parameter set may be indicated in a separate system information message intended to the reduced capability UE(s). In another implementation, the separate paging-related parameter set may be indicated in a system information message intended to both the normal UE(s) and the reduced capability UE(s). A DRX cycle (i.e., paging cycle) of the reduced capability UE(s) may be configured to be longer than a DRX cycle of the normal UE(s). The number of paging frames per DRX cycle and the number of Paging Occasions per Paging Frame may be separately configured based on the number of reduced capability UEs in a cell.

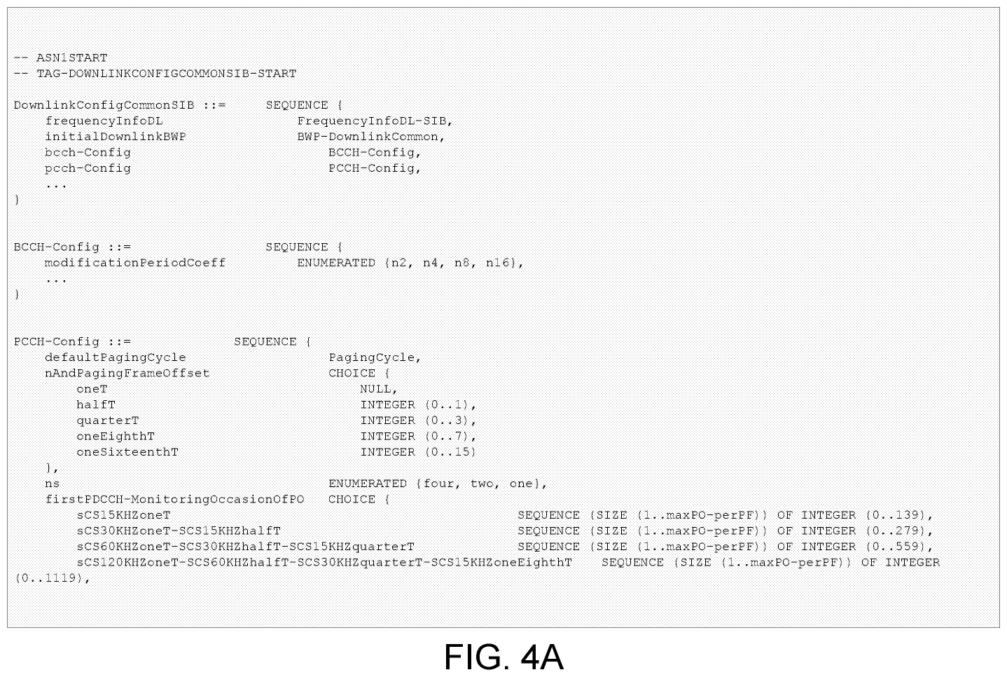

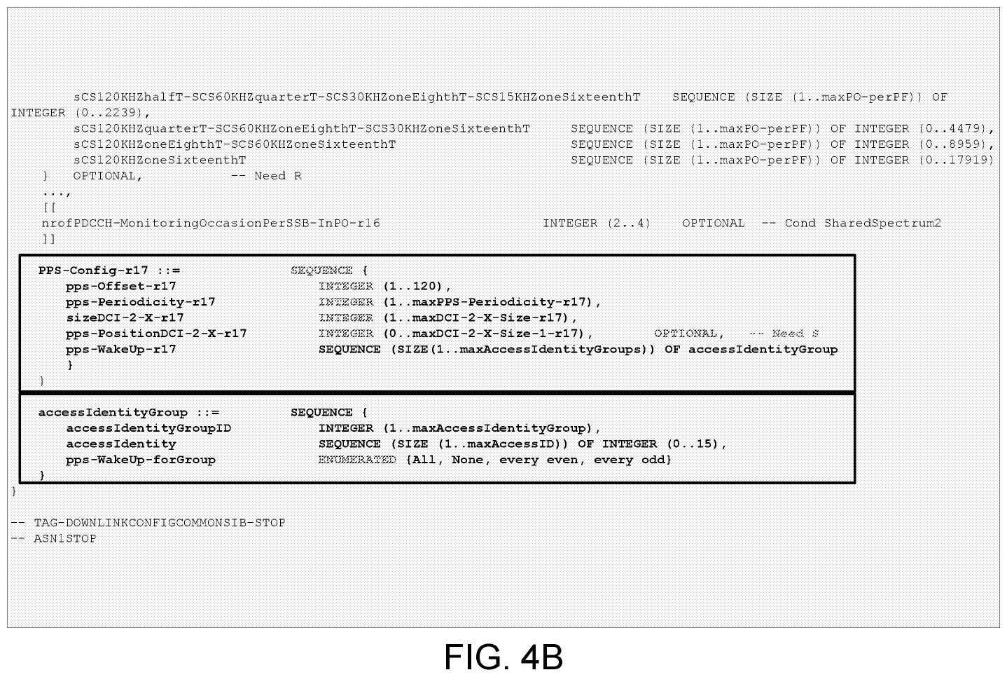

In another embodiment, a DCI format (e.g., DCI format 2_x_{[BWP1]}) of PPS-PDCCH comprises a bit field(s) intended to a normal UE(s) and a bit field(s) intended to a reduced capability UE(s). In one example implementation, an indication of a starting position in DCI format 2_x for the reduced capability UE(s) is included in a paging power saving configuration (the parameter ‘PPS-Config-r17’). Examples of this paging power saving configuration are discussed below with reference to FIGS. 4A-4B. The reduced capability UE(s) 205 will extract bits starting from the indicated position in DCI format 2_x to determine whether to monitor paging DCI in upcoming at least one paging occasion.

In other embodiments, PPS-PDCCH are transmitted separately for a reduced capability UE(s) and a normal UE(s) based on separate monitoring occasions and/or separate RNTI values. In one implementation, a first PPS-PDCCH with CRC scrambled with a first RNTI for a normal UE can be multiplexed with a second PPS-PDCCH with CRC scrambled with a second RNTI for a reduced capability UE in the frequency domain.

In some embodiments, a UE 205 may be operated in a normal UE mode (e.g., a smart phone) for a first time duration and may be operated in a reduced capability UE mode (e.g., a sensor) for a second time duration. For example, a smart phone UE may be operated in a reduced capability sensor mode during the night or when a human user is away from the UE. When a certain operation mode is triggered (e.g., normal mode or reduced capability mode), the UE employs system information, paging, and other operation related parameters corresponding the triggered operation mode. In an embodiment, the UE 205 may be operated with the normal UE mode and the reduced capability UE mode concurrently. In this case, some operation parameters are applicable to both modes and other operational parameters are separately configured, and which parameter set the UE should apply may be indicated implicitly or explicitly.

FIGS. 4A-4B depict one example of a DownlinkConfigCommonSIB information element, according to embodiments of the disclosure. Due to the size its contents, the DownlinkConfigCommonSIB information element is split in two for ease of illustration; however, the DownlinkConfigCommonSIB information element, according to this disclosure is a concatenation of FIG. 4A and FIG. 4B. Included in the DownlinkConfigCommonSIB information element are the following new parameters:
pps-Offset
   The start of the search-time of DCI format 2_x with CRC scrambled by paging power saving (PPS)-RNTI relative to the start of the paging cycle (or the Paging Frame or the Paging Occasion). Value in multiples of 0.125 ms (milliseconds). ‘1’ corresponds to 0.125 ms, ‘2’ corresponds to 0.25 ms, ‘3’ corresponds to 0.375 ms and so on.
pps-Periodicity
Monitoring periodicity for PPS-PDCCH. Value in multiples of a paging cycle.
sizeDCI-2 x
   Size of DCI format 2_x.
pps-WakeUp
   Indicates the UE whether to wake-up and when to wake-up for the following paging cycle(s) before the next PPS-PDCCH monitoring occasion if DCI format 2_x is not detected. The UE determines an applicable configuration for the UE, based on an access identity configured in the UE.
accessIdentityGroup
   Includes a plurality of access identities for an access identity group and a corresponding paging DCI monitoring behaviour for the plurality of access identities. ‘All’ means monitoring paging DCI in all of the following paging cycles before the next PPS-PDCCH monitoring occasion, ‘None’ means do not wake-up until the next PPS-PDCCH monitoring occasion, ‘every even’ and ‘every odd’ mean monitoring paging DCI in every even and every odd paging cycles, respectively, before the next PPS-PDCCH monitoring occasion.
pps-PositionDCI-2_x
   Starting position of reduced cap UE in DCI format 2_x.

In the example shown in FIGS. 4A-4B, a UE 205 may receive an indication within the PPS-PDCCH configuration parameter, where the indication informs the UE 205 whether the UE 205 has to wake-up for paging DCI monitoring in a following number of paging/DRX cycles before the next PPS-PDCCH monitoring occasion, if the UE does not detect PPS-PDCCH in a current PPS-PDCCH monitoring occasion. The paging DCI monitoring behavior may be configured differently depending on a UE access identity.

FIGS. 5A-5B depict one example of an RRCRelease message, according to embodiments of the disclosure. Due to the size its contents, the RRCRelease message is split in two for ease of illustration; however, the RRCRelease message, according to this disclosure is a concatenation of the contents of FIG. 5A and FIG. 5B. Included in the RRCRelease message are the following new parameters:
pps-DedicatedWakeUp
   Indicates the RRC_INACTIVE UE to wake-up for the next paging cycle if DCI format 2_x is not detected. If the field is absent, the RRC_INACTIVE UE does not wake-up for the next paging cycle if DCI format 2_x is not detected.

According to embodiments of a third solution, a UE detects paging DCI on a corresponding paging occasion of a corresponding paging frame of the UE, receives an indication whether to decode a scheduled PDSCH including a paging message in the detected paging DCI, and determines whether to decode the scheduled PDSCH or not. Note that the third solution may be combined with the first and/or second solutions.

In one example implementation, if a UE receives a short message indicator field indicating that DCI includes at least scheduling information for a paging PDSCH (i.e. the PDSCH including a paging message) in the DCI format 1_0 with CRC scrambled by P-RNTI, the UE interprets a full or part of reserved bits (e.g. 8 bits for operation in a cell with shared spectrum channel access; otherwise 6 bits) in the DCI format 1_0 with CRC scrambled by P-RNTI as an indicator whether to decode the paging message. The UE may determine a bit position within the full or part of reserved bits used as the paging message decoding indicator, based on a UE ID.

In another example, the UE may determine a bit position within the full or part of reserved bits used as the paging message decoding indicator, based on a group ID (e.g., the group ID may be configured to the UE by higher layer signaling or determined based on other configurable parameters). Since the maximum possible number of page records in a paging message is 32, in one example, each paging message decoding indication bit of the 6-bit bitfield may correspond to a group of 6 UEs.

This paging message decoding indication can avoid or reduce the probability that the UE unnecessarily decodes a paging PDSCH that does not include a paging record intended to the UE (i.e., the paging record including the corresponding UE ID). In some of the embodiments described, DRX may comprised extended DRX (e-DRX).

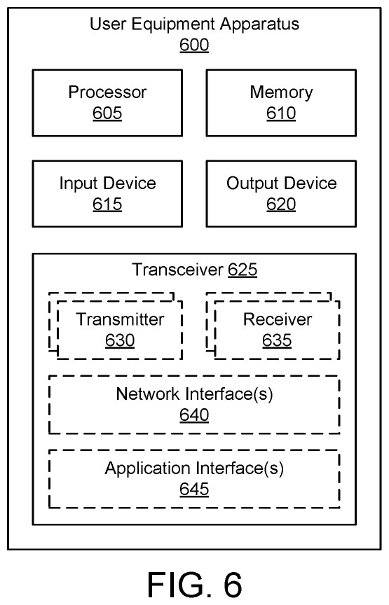

FIG. 6 depicts a user equipment apparatus 600 that may be used for power-efficient paging reception, according to embodiments of the disclosure. In various embodiments, the user equipment apparatus 600 is used to implement one or more of the solutions described above. The user equipment apparatus 600 may be one embodiment of the remote unit 105 and/or the UE 205, described above. Furthermore, the user equipment apparatus 600 may include a processor 605, a memory 610, an input device 615, an output device 620, and a transceiver 625.

In some embodiments, the input device 615 and the output device 620 are combined into a single device, such as a touchscreen. In certain embodiments, the user equipment apparatus 600 may not include any input device 615 and/or output device 620. In various embodiments, the user equipment apparatus 600 may include one or more of: the processor 605, the memory 610, and the transceiver 625, and may not include the input device 615 and/or the output device 620.

As depicted, the transceiver 625 includes at least one transmitter 630 and at least one receiver 635. In some embodiments, the transceiver 625 communicates with one or more cells (or wireless coverage areas) supported by one or more base units 121. In various embodiments, the transceiver 625 is operable on unlicensed spectrum. Moreover, the transceiver 625 may include multiple UE panels supporting one or more beams. Additionally, the transceiver 625 may support at least one network interface 640 and/or application interface 645. The application interface(s) 645 may support one or more APIs. The network interface(s) 640 may support 3GPP reference points, such as Uu, N1, PCS, etc. Other network interfaces 640 may be supported, as understood by one of ordinary skill in the art.

The processor 605, in one embodiment, may include any known controller capable of executing computer-readable instructions and/or capable of performing logical operations. For example, the processor 605 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 605 executes instructions stored in the memory 610 to perform the methods and routines described herein. The processor 605 is communicatively coupled to the memory 610, the input device 615, the output device 620, and the transceiver 625.

In various embodiments, the processor 605 controls the user equipment apparatus 600 to implement the above described UE behaviors. In certain embodiments, the processor 605 may include an application processor (also known as “main processor”) which manages application-domain and operating system (“OS”) functions and a baseband processor (also known as “baseband radio processor”) which manages radio functions.

In various embodiments, the processor 605 controls the transceiver 625 to receive a PDCCH configuration of a first DCI format, where the PDCCH configuration includes a search space configuration of the first DCI format. The processor 605 detects the first DCI format (e.g., of PPS-PDCCH) by monitoring the first DCI format according to the search space configuration, where the first DCI format indicates whether the apparatus 600 is to monitor for paging DCI of a second DCI format. The processor 605 monitors for paging DCI of the second DCI format in a paging period (e.g., paging cycle, DRX cycle used for determining a Paging Frame and a Paging Occasion, or SI modification period) based on the detected first DCI format.

In some embodiments, the PDCCH configuration of the first DCI format is received as a part of system information. In certain embodiments, the first DCI format may be common control information transmitted to a plurality of UEs camping on a cell or being served by the cell. In one embodiment, the first DCI format is intended to a group of UEs camping on the cell or being served by the cell. In another embodiment, the first DCI format is intended to all UEs camping on the cell or being served by the cell.

In some embodiments, the processor 605 determines a paging frame and a paging occasion of the paging frame associated with the apparatus 600 based on a UE identity, where the processor 605 further determines an RNTI value to be used for detecting the first DCI format. In such embodiments, the RNTI value may be determined based on a paging frame index of the paging frame, a paging occasion index of the paging occasion, and/or the UE identity.

In some embodiments, the paging period comprises at least one of: a DRX cycle and a system information modification period. In some embodiments, the search space configuration of the first DCI format includes a monitoring periodicity. In such embodiments, the monitoring periodicity is one or multiple of a time period selected from one of: a DRX cycle and a system information modification period.

In some embodiments, the detected first DCI format indicates to the processor 605 to transition the apparatus 600 from an inactive mode (e.g., RRC_INACTIVE) to an idle mode (e.g., RRC_IDLE). In some embodiments, the PDCCH configuration of the first DCI format includes information of bit field configuration. In such embodiments, the bit field configuration may include at least one of: a size of the first DCI format, a number of Paging Frames associated with the first DCI format, and a number of Paging Occasions associated with the first DCI format.

In some embodiments, the PDCCH configuration includes information of whether to monitor the paging DCI of the second DCI format in the paging period in response to not detecting the first DCI format. In such embodiments, the information may be associated with at least one access identity configured in the apparatus 600. In some embodiments, the processor 605 determines a group identity and determines whether to monitor the paging DCI of the second DCI format based on the detected first DCI format and the group identity.

The memory 610, in one embodiment, is a computer readable storage medium. In some embodiments, the memory 610 includes volatile computer storage media. For example, the memory 610 may include a RAM, including dynamic RAM (“DRAM”), synchronous dynamic RAM (“SDRAM”), and/or static RAM (“SRAM”). In some embodiments, the memory 610 includes non-volatile computer storage media. For example, the memory 610 may include a hard disk drive, a flash memory, or any other suitable non-volatile computer storage device. In some embodiments, the memory 610 includes both volatile and non-volatile computer storage media.

In some embodiments, the memory 610 stores data related to power-efficient paging reception. For example, the memory 610 may store various parameters, panel/beam configurations, resource assignments, policies, and the like as described above. In certain embodiments, the memory 610 also stores program code and related data, such as an operating system or other controller algorithms operating on the apparatus 600.

The input device 615, in one embodiment, may include any known computer input device including a touch panel, a button, a keyboard, a stylus, a microphone, or the like. In some embodiments, the input device 615 may be integrated with the output device 620, for example, as a touchscreen or similar touch-sensitive display. In some embodiments, the input device 615 includes a touchscreen such that text may be input using a virtual keyboard displayed on the touchscreen and/or by handwriting on the touchscreen. In some embodiments, the input device 615 includes two or more different devices, such as a keyboard and a touch panel.

The output device 620, in one embodiment, is designed to output visual, audible, and/or haptic signals. In some embodiments, the output device 620 includes an electronically controllable display or display device capable of outputting visual data to a user. For example, the output device 620 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 620 may include a wearable display separate from, but communicatively coupled to, the rest of the user equipment apparatus 600, such as a smart watch, smart glasses, a heads-up display, or the like. Further, the output device 620 may be a component of a smart phone, a personal digital assistant, a television, a table computer, a notebook (laptop) computer, a personal computer, a vehicle dashboard, or the like.

In certain embodiments, the output device 620 includes one or more speakers for producing sound. For example, the output device 620 may produce an audible alert or notification (e.g., a beep or chime). In some embodiments, the output device 620 includes one or more haptic devices for producing vibrations, motion, or other haptic feedback. In some embodiments, all or portions of the output device 620 may be integrated with the input device 615. For example, the input device 615 and output device 620 may form a touchscreen or similar touch-sensitive display. In other embodiments, the output device 620 may be located near the input device 615.

The transceiver 625 communicates with one or more network functions of a mobile communication network via one or more access networks. The transceiver 625 operates under the control of the processor 605 to transmit messages, data, and other signals and also to receive messages, data, and other signals. For example, the processor 605 may selectively activate the transceiver 625 (or portions thereof) at particular times in order to send and receive messages.

The transceiver 625 includes at least transmitter 630 and at least one receiver 635. One or more transmitters 630 may be used to provide UL communication signals to a base unit 121, such as the UL transmissions described herein. Similarly, one or more receivers 635 may be used to receive DL communication signals from the base unit 121, as described herein. Although only one transmitter 630 and one receiver 635 are illustrated, the user equipment apparatus 600 may have any suitable number of transmitters 630 and receivers 635. Further, the transmitter(s) 630 and the receiver(s) 635 may be any suitable type of transmitters and receivers. In one embodiment, the transceiver 625 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 625, transmitters 630, and receivers 635 may be implemented as physically separate components that access a shared hardware resource and/or software resource, such as for example, the network interface 640.

In various embodiments, one or more transmitters 630 and/or one or more receivers 635 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 630 and/or one or more receivers 635 may be implemented and/or integrated into a multi-chip module. In some embodiments, other components such as the network interface 640 or other hardware components/circuits may be integrated with any number of transmitters 630 and/or receivers 635 into a single chip. In such embodiment, the transmitters 630 and receivers 635 may be logically configured as a transceiver 625 that uses one more common control signals or as modular transmitters 630 and receivers 635 implemented in the same hardware chip or in a multi-chip module.

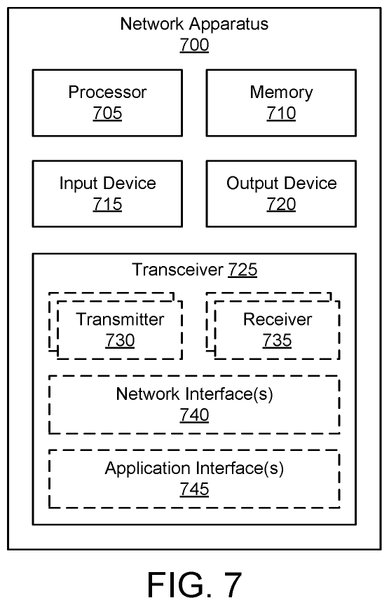

FIG. 7 depicts a network apparatus 700 that may be used for power-efficient paging reception, according to embodiments of the disclosure. In one embodiment, network apparatus 700 may be one implementation of a RAN node, such as the base unit 121 and/or the RAN node 210, as described above. Furthermore, the base network apparatus 700 may include a processor 705, a memory 710, an input device 715, an output device 720, and a transceiver 725.

In some embodiments, the input device 715 and the output device 720 are combined into a single device, such as a touchscreen. In certain embodiments, the network apparatus 700 may not include any input device 715 and/or output device 720. In various embodiments, the network apparatus 700 may include one or more of: the processor 705, the memory 710, and the transceiver 725, and may not include the input device 715 and/or the output device 720.

As depicted, the transceiver 725 includes at least one transmitter 730 and at least one receiver 735. Here, the transceiver 725 communicates with one or more remote units 75. Additionally, the transceiver 725 may support at least one network interface 740 and/or application interface 745. The application interface(s) 745 may support one or more APIs. The network interface(s) 740 may support 3GPP reference points, such as Uu, N1, N2 and N3. Other network interfaces 740 may be supported, as understood by one of ordinary skill in the art.

The processor 705, in one embodiment, may include any known controller capable of executing computer-readable instructions and/or capable of performing logical operations. For example, the processor 705 may be a microcontroller, a microprocessor, a CPU, a GPU, an auxiliary processing unit, a FPGA, or similar programmable controller. In some embodiments, the processor 705 executes instructions stored in the memory 710 to perform the methods and routines described herein. The processor 705 is communicatively coupled to the memory 710, the input device 715, the output device 720, and the transceiver 725.

In various embodiments, the network apparatus 700 is a RAN node (e.g., gNB) that communicates with one or more UEs, as described herein. In such embodiments, the processor 705 controls the network apparatus 700 to perform the above described RAN behaviors. When operating as a RAN node, the processor 705 may include an application processor (also known as “main processor”) which manages application-domain and operating system (“OS”) functions and a baseband processor (also known as “baseband radio processor”) which manages radio functions.

In various embodiments, the processor 705 controls the transceiver 725 to transmit a PDCCH configuration of a first DCI format to a UE, where the PDCCH configuration includes a search space configuration of the first DCI format. The transceiver 725 transmits the first DCI format (e.g., of PPS-PDCCH) according to the search space configuration, where the first DCI format indicates that the UE is to monitor for paging DCI of a second DCI format. The transceiver 725 transmits paging DCI of the second DCI format in a paging period (e.g., paging cycle, DRX cycle used for determining a Paging Frame and a Paging Occasion, or SI modification period) indicated by the transmitted first DCI format.

In some embodiments, the PDCCH configuration of the first DCI format is transmitted as a part of system information and the first DCI format is common control information transmitted to a plurality of UE camping on a cell or being served by the cell. In some embodiments, the detected first DCI format indicates to the UE to transition from an inactive mode (e.g., RRC_INACTIVE) to an idle mode (e.g., RRC_IDLE).

In some embodiments, the paging period comprises at least one of: a DRX cycle and a system information modification period. In some embodiments, the search space configuration of the first DCI format includes a monitoring periodicity. In certain embodiments, the monitoring periodicity is one or multiple of a time period selected from one of: a DRX cycle and a system information modification period.

In some embodiments, the PDCCH configuration of the first DCI format includes information of bit field configuration. In certain embodiments, the bit field configuration comprises at least one selected from a size of the first DCI format, a number of Paging Frames associated with the first DCI format, and a number of Paging Occasions associated with the first DCI format.

In some embodiments, the PDCCH configuration includes information of whether the UE is to monitor the paging DCI of the second DCI format in the paging period in response to not detecting the first DCI format. In such embodiments, the information may be associated with at least one access identity configured in the UE. In some embodiments, the paging DCI includes at least one of: scheduling information for a paging message and a short message.

The memory 710, in one embodiment, is a computer readable storage medium. In some embodiments, the memory 710 includes volatile computer storage media. For example, the memory 710 may include a RAM, including dynamic RAM (“DRAM”), synchronous dynamic RAM (“SDRAM”), and/or static RAM (“SRAM”). In some embodiments, the memory 710 includes non-volatile computer storage media. For example, the memory 710 may include a hard disk drive, a flash memory, or any other suitable non-volatile computer storage device. In some embodiments, the memory 710 includes both volatile and non-volatile computer storage media.

In some embodiments, the memory 710 stores data related to power-efficient paging reception. For example, the memory 710 may store parameters, configurations, resource assignments, policies, and the like, as described above. In certain embodiments, the memory 710 also stores program code and related data, such as an operating system or other controller algorithms operating on the apparatus 700.

The input device 715, in one embodiment, may include any known computer input device including a touch panel, a button, a keyboard, a stylus, a microphone, or the like. In some embodiments, the input device 715 may be integrated with the output device 720, for example, as a touchscreen or similar touch-sensitive display. In some embodiments, the input device 715 includes a touchscreen such that text may be input using a virtual keyboard displayed on the touchscreen and/or by handwriting on the touchscreen. In some embodiments, the input device 715 includes two or more different devices, such as a keyboard and a touch panel.

The output device 720, in one embodiment, is designed to output visual, audible, and/or haptic signals. In some embodiments, the output device 720 includes an electronically controllable display or display device capable of outputting visual data to a user. For example, the output device 720 may include, but is not limited to, an LCD display, an LED display, an OLED display, a projector, or similar display device capable of outputting images, text, or the like to a user. As another, non-limiting, example, the output device 720 may include a wearable display separate from, but communicatively coupled to, the rest of the network apparatus 700, such as a smart watch, smart glasses, a heads-up display, or the like. Further, the output device 720 may be a component of a smart phone, a personal digital assistant, a television, a table computer, a notebook (laptop) computer, a personal computer, a vehicle dashboard, or the like.

In certain embodiments, the output device 720 includes one or more speakers for producing sound. For example, the output device 720 may produce an audible alert or notification (e.g., a beep or chime). In some embodiments, the output device 720 includes one or more haptic devices for producing vibrations, motion, or other haptic feedback. In some embodiments, all or portions of the output device 720 may be integrated with the input device 715. For example, the input device 715 and output device 720 may form a touchscreen or similar touch-sensitive display. In other embodiments, the output device 720 may be located near the input device 715.

The transceiver 725 includes at least transmitter 730 and at least one receiver 735. One or more transmitters 730 may be used to communicate with the UE, as described herein. Similarly, one or more receivers 735 may be used to communicate with network functions in the PLMN and/or RAN, as described herein. Although only one transmitter 730 and one receiver 735 are illustrated, the network apparatus 700 may have any suitable number of transmitters 730 and receivers 735. Further, the transmitter(s) 730 and the receiver(s) 735 may be any suitable type of transmitters and receivers.

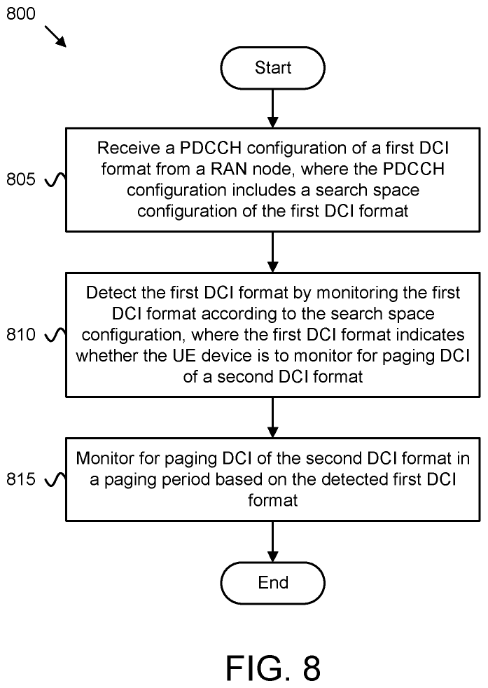

FIG. 8 depicts one embodiment of a method 800 for power-efficient paging reception, according to embodiments of the disclosure. In various embodiments, the method 800 is performed by a user equipment device in a mobile communication network, such as the remote unit 105, the first UE 201, second UE 203, and/or the user equipment apparatus 600, described above. In some embodiments, the method 800 is performed by a processor, such as a microcontroller, a microprocessor, a CPU, a GPU, an auxiliary processing unit, a FPGA, or the like.

The method 800 begins and receives 805 a PDCCH configuration of a first DCI format from a RAN node, where the PDCCH configuration includes a search space configuration of the first DCI format. The method 800 includes detecting 810 the first DCI format (e.g., of PPS-PDCCH) by monitoring the first DCI format according to the search space configuration, where the first DCI format indicates whether the UE device is to monitor for paging DCI of a second DCI format. The method 800 includes monitoring 815 for paging DCI of the second DCI format in a paging period (e.g., paging cycle, DRX cycle used for determining a Paging Frame and a Paging Occasion, or SI modification period) based on the detected first DCI format. The method 800 ends.

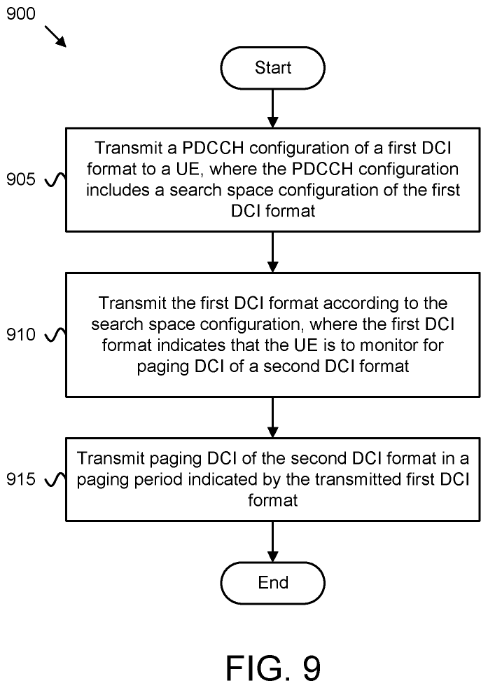

FIG. 9 depicts one embodiment of a method 900 for power-efficient paging reception, according to embodiments of the disclosure. In various embodiments, the method 900 is performed by a RAN device in a mobile communication network, such as the base unit 121, the RAN node 210 and/or the network apparatus 700, described above. In some embodiments, the method 900 is performed by a processor, such as a microcontroller, a microprocessor, a CPU, a GPU, an auxiliary processing unit, a FPGA, or the like.

The method 900 begins and transmits 905 to a UE a PDCCH configuration of a first DCI format, where the PDCCH configuration includes a search space configuration of the first DCI format. The method 900 includes transmitting 910 the first DCI format (e.g., of PPS-PDCCH) according to the search space configuration, where the first DCI format indicates that the UE is to monitor for paging DCI of a second DCI format. The method 900 includes transmitting 915 paging DCI of the second DCI format in a paging period (e.g., paging cycle, DRX cycle used for determining a Paging Frame and a Paging Occasion, or SI modification period) indicated by the transmitted first DCI format. The method 900 ends.

Disclosed herein is a first apparatus power-efficient paging reception, according to embodiments of the disclosure. The first apparatus may be implemented by a user equipment device in a mobile communication network, such as the remote unit 105, the UE 205, and/or the user equipment apparatus 600, described above. The first apparatus includes a processor and a transceiver that receives a PDCCH configuration of a first DCI format, where the PDCCH configuration includes a search space configuration of the first DCI format. The processor detects the first DCI format (e.g., of PPS-PDCCH) by monitoring the first DCI format according to the search space configuration, where the first DCI format indicates whether the first apparatus is to monitor for paging DCI of a second DCI format. The processor monitors for paging DCI of the second DCI format in a paging period (e.g., paging cycle, DRX cycle used for determining a Paging Frame and a Paging Occasion, or SI modification period) based on the detected first DCI format.

In some embodiments, the PDCCH configuration of the first DCI format is received as a part of system information. In certain embodiments, the first DCI format may be common control information transmitted to a plurality of UEs camping on a cell or being served by the cell. In one embodiment, the first DCI format is intended to a group of UEs camping on the cell or being served by the cell. In another embodiment, the first DCI format is intended to all UEs camping on the cell or being served by the cell.

In some embodiments, the processor determines a paging frame and a paging occasion of the paging frame associated with the first apparatus based on a UE identity, where the processor further determines an RNTI value to be used for detecting the first DCI format. In such embodiments, the RNTI value may be determined based on a paging frame index of the paging frame, a paging occasion index of the paging occasion, and/or the UE identity.

In some embodiments, the paging period comprises at least one of: a DRX cycle and a system information modification period. In some embodiments, the search space configuration of the first DCI format includes a monitoring periodicity. In such embodiments, the monitoring periodicity is one or multiple of a time period selected from one of: a DRX cycle and a system information modification period.

In some embodiments, the detected first DCI format indicates to the processor to transition from an inactive mode (e.g., RRC_INACTIVE) to an idle mode (e.g., RRC_IDLE). In some embodiments, the PDCCH configuration of the first DCI format includes information of bit field configuration. In such embodiments, the bit field configuration may include at least one of: a size of the first DCI format, a number of Paging Frames associated with the first DCI format, and a number of Paging Occasions associated with the first DCI format.

In some embodiments, the PDCCH configuration includes information of whether to monitor the paging DCI of the second DCI format in the paging period in response to not detecting the first DCI format. In such embodiments, the information may be associated with at least one access identity configured in the first apparatus. In some embodiments, the processor determines a group identity and determines whether to monitor the paging DCI of the second DCI format based on the detected first DCI format and the group identity.

Disclosed herein is a first method for power-efficient paging reception, according to embodiments of the disclosure. The first method may be performed by a user equipment device in a mobile communication network, such as the remote unit 105, the UE 205, and/or the user equipment apparatus 600, described above. The first method includes receiving, from a RAN node, a PDCCH configuration of a first DCI format, where the PDCCH configuration includes a search space configuration of the first DCI format. The first method includes detecting the first DCI format (e.g., of PPS-PDCCH) by monitoring the first DCI format according to the search space configuration, where the first DCI format indicates whether the UE device is to monitor for paging DCI of a second DCI format. The first method includes monitoring for paging DCI of the second DCI format in a paging period (e.g., paging cycle, DRX cycle used for determining a Paging Frame and a Paging Occasion, or SI modification period) based on the detected first DCI format.

In some embodiments, the PDCCH configuration of the first DCI format is received as a part of system information. In certain embodiments, the first DCI format may be common control information transmitted to a plurality of UEs camping on a cell or being served by the cell. In one embodiment, the first DCI format is intended to a group of UEs camping on the cell or being served by the cell. In another embodiment, the first DCI format is intended to all UEs camping on the cell or being served by the cell.

In some embodiments, the first method includes determines a paging frame and a paging occasion of the paging frame associated with the UE device based on a UE identity and determining an RNTI value to be used for detecting the first DCI format. In such embodiments, the RNTI value may be determined based on a paging frame index of the paging frame, a paging occasion index of the paging occasion, and/or the UE identity.

In some embodiments, the paging period comprises at least one of: a DRX cycle and a system information modification period. In some embodiments, the search space configuration of the first DCI format includes a monitoring periodicity. In such embodiments, the monitoring periodicity is one or multiple of a time period selected from one of: a DRX cycle and a system information modification period.

In some embodiments, the detected first DCI format indicates to the UE device to transition from an inactive mode (e.g., RRC_INACTIVE) to an idle mode (e.g., RRC_IDLE). In some embodiments, the paging DCI includes at least one of: scheduling information for a paging message and a short message.

In some embodiments, the PDCCH configuration of the first DCI format includes information of bit field configuration. In such embodiments, the bit field configuration may include at least one of: a size of the first DCI format, a number of Paging Frames associated with the first DCI format, and a number of Paging Occasions associated with the first DCI format.

In some embodiments, the PDCCH configuration includes information of whether to monitor the paging DCI of the second DCI format in the paging period in response to not detecting the first DCI format. In such embodiments, the information may be associated with at least one access identity configured in the UE device. In some embodiments, the first method includes determining a group identity and determines whether to monitor the paging DCI of the second DCI format based on the detected first DCI format and the group identity.

Disclosed herein is a second apparatus for power-efficient paging reception, according to embodiments of the disclosure. The second apparatus may be implemented by a RAN device in a mobile communication network, such as the base unit 121, the RAN node 210, and/or the network apparatus 600, described above. The second apparatus includes a processor and a transceiver that transmits a PDCCH configuration of a first DCI format to a UE device, where the PDCCH configuration includes a search space configuration of the first DCI format. The transceiver transmits the first DCI format (e.g., of PPS-PDCCH) according to the search space configuration, where the first DCI format indicates that the UE device is to monitor for paging DCI of a second DCI format. The transceiver transmits paging DCI of the second DCI format in a paging period (e.g., paging cycle, DRX cycle used for determining a Paging Frame and a Paging Occasion, or SI modification period) indicated by the transmitted first DCI format.

In some embodiments, the PDCCH configuration of the first DCI format is transmitted as a part of system information and the first DCI format is common control information transmitted to a plurality of UE devices camping on a cell or being served by the cell. In some embodiments, the detected first DCI format indicates to the UE device to transition from an inactive mode (e.g., RRC_INACTIVE) to an idle mode (e.g., RRC_IDLE).

In some embodiments, the paging period comprises at least one of: a DRX cycle and a system information modification period. In some embodiments, the search space configuration of the first DCI format includes a monitoring periodicity. In certain embodiments, the monitoring periodicity is one or multiple of a time period selected from one of: a DRX cycle and a system information modification period.

In some embodiments, the PDCCH configuration of the first DCI format includes information of bit field configuration. In certain embodiments, the bit field configuration comprises at least one selected from a size of the first DCI format, a number of Paging Frames associated with the first DCI format, and a number of Paging Occasions associated with the first DCI format.

In some embodiments, the PDCCH configuration includes information of whether the UE device is to monitor the paging DCI of the second DCI format in the paging period in response to not detecting the first DCI format. In such embodiments, the information may be associated with at least one access identity configured in the UE device. In some embodiments, the paging DCI includes at least one of: scheduling information for a paging message and a short message.

Disclosed herein is a second method for power-efficient paging reception, according to embodiments of the disclosure. The second method may be performed by a RAN device in a mobile communication network, such as the base unit 121, the RAN node 210, and/or the network apparatus 600, described above. The second method includes transmitting to a UE device a PDCCH configuration of a first DCI format, where the PDCCH configuration includes a search space configuration of the first DCI format. The second method includes transmitting the first DCI format (e.g., of PPS-PDCCH) according to the search space configuration, where the first DCI format indicates that the UE device is to monitor for paging DCI of a second DCI format. The second method includes transmitting paging DCI of the second DCI format in a paging period (e.g., paging cycle, DRX cycle used for determining a Paging Frame and a Paging Occasion, or SI modification period) indicated by the transmitted first DCI format.

In some embodiments, the PDCCH configuration of the first DCI format is transmitted as a part of system information and the first DCI format is common control information transmitted to a plurality of UE devices camping on a cell or being served by the cell. In some embodiments, the detected first DCI format indicates to the UE device to transition from an inactive mode (e.g., RRC_INACTIVE) to an idle mode (e.g., RRC_IDLE).

In some embodiments, the paging period comprises at least one of: a DRX cycle and a system information modification period. In some embodiments, the search space configuration of the first DCI format includes a monitoring periodicity. In certain embodiments, the monitoring periodicity is one or multiple of a time period selected from one of: a DRX cycle and a system information modification period.

In some embodiments, the PDCCH configuration of the first DCI format includes information of bit field configuration. In certain embodiments, the bit field configuration comprises at least one selected from a size of the first DCI format, a number of Paging Frames associated with the first DCI format, and a number of Paging Occasions associated with the first DCI format.

In some embodiments, the PDCCH configuration includes information of whether the UE device is to monitor the paging DCI of the second DCI format in the paging period in response to not detecting the first DCI format. In such embodiments, the information may be associated with at least one access identity configured in the UE device. In some embodiments, the paging DCI includes at least one of: scheduling information for a paging message and a short message.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1.-15. (canceled)

16. A User Equipment (“UE”) apparatus comprising:
a memory; and
a processor coupled to a memory, the processor configured to cause the apparatus to:
receive, from a Radio Access Network (“RAN”) node, a Physical Downlink Control Channel (“PDCCH”) configuration of a first Downlink Control Information (“DCI”) format, wherein the PDCCH configuration includes a search space configuration of the first DCI format;
detect the first DCI format by monitoring the first DCI format according to the search space configuration, wherein the first DCI format indicates whether the UE device is to monitor for paging DCI of a second DCI format; and
monitor for paging DCI of the second DCI format in a paging period based on the detected first DCI format.

17. The apparatus of claim 16, wherein the apparatus receives the PDCCH configuration of the first DCI format as a part of system information and wherein the first DCI format comprises common control information transmitted to a plurality of UEs camping on a cell or being served by the cell.

18. The apparatus of claim 16, wherein the processor is configured to cause the apparatus to:
determine a paging frame and a paging occasion of the paging frame associated with the UE device based on a UE identity; and
determine a Radio Network Temporary Identifier (“RNTI”) value to be used for detecting the first DCI format, wherein the RNTI value is determined based on at least one of:
a paging frame index of the paging frame,
a paging occasion index of the paging occasion,
the UE identity,
or a combination thereof.

19. The apparatus of claim 16, wherein the detected first DCI format indicates to the UE device to transition from an inactive mode to an idle mode.

20. The apparatus of claim 16, wherein the paging period comprises at least one of:
a Discontinuous Reception (“DRX”) cycle,
a system information modification period,
or a combination thereof.

21. The apparatus of claim 16, wherein the search space configuration of the first DCI format includes a monitoring periodicity, wherein the monitoring periodicity is one or multiple of a time period selected from one of:
a Discontinuous Reception (“DRX”) cycle, or
a system information modification period.

22. The apparatus of claim 16, wherein the PDCCH configuration of the first DCI format includes information of bit field configuration, wherein the bit field configuration comprises at least one information selected from:
a size of the first DCI format,
a number of Paging Frames associated with the first DCI format,
a number of Paging Occasions associated with the first DCI format,
or a combination thereof.

23. The apparatus of claim 16, wherein the PDCCH configuration includes information of whether to monitor the paging DCI of the second DCI format in the paging period in response to not detecting the first DCI format.

24. The apparatus of claim 23, wherein the information is associated with at least one access identity configured in the UE device.

25. The apparatus of claim 16, wherein the processor is configured to cause the apparatus to:
determine a group identity; and
determine whether to monitor the paging DCI of the second DCI format based on the detected first DCI format and the group identity.

26. A method at a User Equipment (“UE”), the method comprising:
receiving, from Radio Access Network (“RAN”) node, a Physical Downlink Control Channel (“PDCCH”) configuration of a first Downlink Control Information (“DCI”) format, wherein the PDCCH configuration includes a search space configuration of the first DCI format;
detecting the first DCI format by monitoring the first DCI format according to the search space configuration, wherein the first DCI format indicates whether the UE device is to monitor for paging DCI of a second DCI format; and
monitoring for paging DCI of the second DCI format in a paging period based on the detected first DCI format.

27. A Radio Access Network (“RAN”) apparatus comprising:
a memory; and
a processor coupled to the memory, the processor configured to cause the apparatus to:
transmit, to a User Equipment (“UE”) device, a Physical Downlink Control Channel (“PDCCH”) configuration of a first Downlink Control Information (“DCI”) format, wherein the PDCCH configuration includes a search space configuration of the first DCI format;
transmit the first DCI format according to the search space configuration, wherein the first DCI format indicates that the UE device is to monitor for paging DCI of a second DCI format; and
transmit paging DCI of the second DCI format in a paging period indicated by the transmitted first DCI format.

28. The apparatus of claim 27, wherein the PDCCH configuration of the first DCI format is transmitted as a part of system information and wherein the first DCI format is common control information transmitted to a plurality of UE devices camping on a cell or being served by the cell.

29. The apparatus of claim 27, wherein the detected first DCI format indicates to the UE device to transition from an inactive mode to an idle mode.

30. The apparatus of claim 27, wherein the paging period comprises at least one of:
a Discontinuous Reception (“DRX”) cycle,
a system information modification period,
or a combination thereof.

31. The apparatus of claim 27, wherein the search space configuration of the first DCI format includes a monitoring periodicity, wherein the monitoring periodicity is one or multiple of a time period selected from one of:
a Discontinuous Reception (“DRX”) cycle, or
a system information modification period.

32. The apparatus of claim 27, wherein the PDCCH configuration of the first DCI format includes information of bit field configuration, wherein the bit field configuration comprises at least one selected from a size of the first DCI format, a number of Paging Frames associated with the first DCI format, and a number of Paging Occasions associated with the first DCI format.

33. The apparatus of claim 27, wherein the PDCCH configuration includes information of whether the UE device is to monitor the paging DCI of the second DCI format in the paging period in response to not detecting the first DCI format.

34. The apparatus of claim 33, wherein the information is associated with at least one access identity configured in the UE device.

35. The apparatus of claim 27, wherein the paging DCI includes at least one of: scheduling information for a paging message and a short message.
